(19) United States
(12) Patent Application Publication
(10) Pub. No.: US 2018/0056522 A1
(43) Pub. Date: Mar. 1, 2018

(54) Portable Box Inverter

(71) Applicant: Advanced Ag Concepts Inc., Eureka, IL (US)

(72) Inventor: Benjamin G. Zimmerman, Eureka, IL (US)

(73) Assignee: Advanced Ag Concepts Inc.

(21) Appl. No.: 15/245,744

(22) Filed: Aug. 24, 2016

(51) Int. Cl. B25J 15/00

(52) U.S. Cl. CPC B25J 15/0028

(57) ABSTRACT

A portable box inverter which includes removable and adjustable grippers capable of grasping and inverting a wide variety of different types of containers. The portable box inverter generally includes a base unit including a rotatable bearing. An arm adjustment hub is connected to the bearing; with a pair of spanner arms extending outwardly in either direction from the arm adjustment hub. The distal ends of each respective spanner arm includes a hingedly attached gripper arm extending outwardly therefrom. A plurality of grippers may be removably and adjustably connected to the gripper arms in various configurations to grip various types of containers. By rotating the arm adjustment hub, the gripper arms may be opened to surround a container and closed to engage the container. By rotating the bearing, the container may be inverted to unload its contents and then returned to its original, upright position.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND

### Field

Example embodiments in general relate to a portable box inverter which includes removable and adjustable grippers capable of grasping and inverting a wide variety of different types of containers.

### Related Art

Any discussion of the related art throughout the specification should in no way be considered as an admission that such related art is widely known or forms part of common general knowledge in the field.

Box inverters are common in a wide range of industries. These inverters are utilized to easily and quickly invert boxes, such as to dump out the contents of the boxes or to aid in stacking the boxes. However, existing inverters suffer from a number of shortcomings. First, inverters in the prior art tend to be fixed in application; meaning that they are only adapted for use with containers having specific dimensions. Additionally, inverters in the prior art may be inefficient in operation as well as difficult to use and maintain.

### SUMMARY

An example embodiment of the present invention is directed to a portable box inverter. The portable box inverter includes a base unit including a rotatable bearing. An arm adjustment hub is connected to the bearing; with a pair of spanner arms extending outwardly in either direction from the arm adjustment hub. The distal ends of each respective spanner arm includes a hingedly attached gripper arm extending outwardly therefrom. A plurality of grippers may be removably and adjustably connected to the gripper arms in various configurations to grip various types of containers. By rotating the arm adjustment hub, the gripper arms may be opened to surround a container and closed to engage the container. By rotating the bearing, the container may be inverted to unload its contents and then returned to its original, upright position.

There has thus been outlined, rather broadly, some of the features of the portable box inverter in order that the detailed description thereof may be better understood, and in order that the present contribution to the art may be better appreciated. There are additional features of the portable box inverter that will be described hereinafter and that will form the subject matter of the claims appended hereto. In this respect, before explaining at least one embodiment of the portable box inverter in detail, it is to be understood that the portable box inverter is not limited in its application to the details of construction or to the arrangements of the components set forth in the following description or illustrated in the drawings. The portable box inverter is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Example embodiments will become more fully understood from the detailed description given herein below and the accompanying drawings, wherein like elements are represented by like reference characters, which are given by way of illustration only and thus are not limitative of the example embodiments herein.

FIG. 1 is a perspective view of a portable box inverter in accordance with an example embodiment.

FIG. 2 is a perspective view of a portable box inverter in accordance with an example embodiment in which the gripper arms are in an opened position to receive a container.

FIG. 3 is a perspective view of a portable box inverter in accordance with an example embodiment holding a container in an upright position.

FIG. 4 is a perspective view of a portable box inverter in accordance with an example embodiment having rotated a container by 90 degrees.

FIG. 5 is a perspective view of a portable box inverter in accordance with an example embodiment having inverted a container by 180 degrees.

FIG. 6 is a top view of a portable box inverter in accordance with an example embodiment.

FIG. 7 is a top view of a portable box inverter in accordance with an example embodiment illustrating opening of the gripper arms and adjustment of the grippers.

FIG. 8 is a frontal view of a portable box inverter in accordance with an example embodiment.

FIG. 9 is a rear view of a portable box inverter in accordance with an example embodiment.

FIG. 10 is a first side view of a portable box inverter in accordance with an example embodiment.

FIG. 11 is a second side view of a portable box inverter in accordance with an example embodiment.

FIG. 12 is a side sectional view of a portable box inverter in accordance with an example embodiment.

FIG. 13 is a perspective view of a portable box inverter in accordance with an example embodiment illustrating connection of grippers on the gripper arms.

FIG. 14 is a perspective view of a portable box inverter in accordance with an example embodiment illustrating adjustment of grippers on the gripper arms.

FIG. 15 is a perspective view of a portable box inverter in accordance with an example embodiment illustrating the spring cushions on the grippers.

### DETAILED DESCRIPTION

### A. Overview.

An example portable box inverter generally comprises a base unit 20 which includes a rotatable bearing 30. An arm adjustment hub 70 is connected to the bearing 30; with a pair of spanner arms 40, 45 extending outwardly in either direction from the arm adjustment hub 70. The distal ends of each respective spanner arm 40, 45 includes a hingedly attached gripper arm 50, 55 extending outwardly therefrom. A plurality of grippers 60 may be removably and adjustably connected to the gripper arms 50, 55 in various configurations to grip various types of containers 12. By rotating the arm adjustment hub 70, the gripper arms 50, 55 may be opened to surround a container 12 and closed to engage the container 12. By rotating the bearing 30, the container 12 may be inverted to unload its contents and then returned to its original, upright position.

### B. Base Unit.

As shown throughout the figures, a base unit 20 is adapted to be removably connected to a vehicle such as a loader or the like. The base unit 20 houses the motors 35, 80 of the present invention; with the bearing 30 and arm adjustment hub 70 both being connected to the base unit 20.

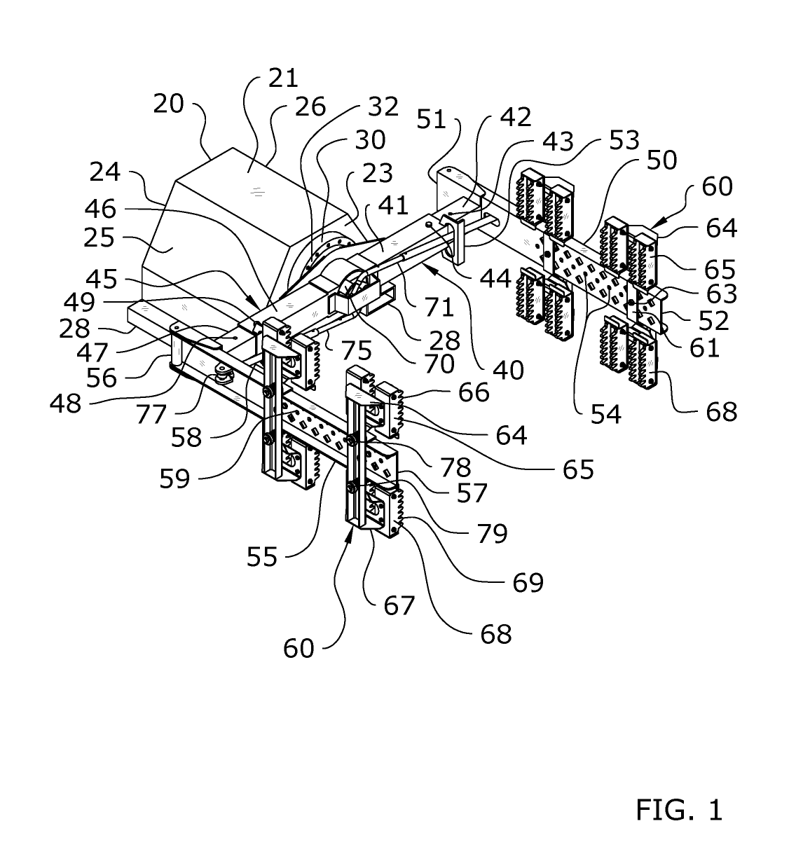

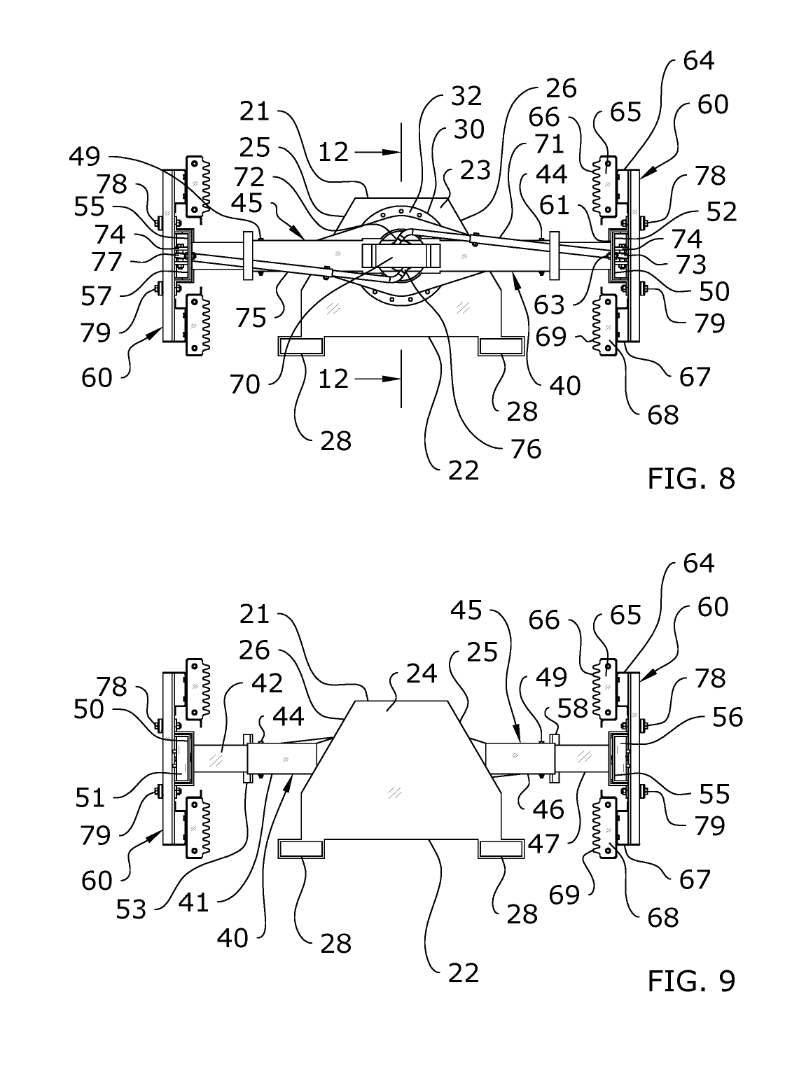

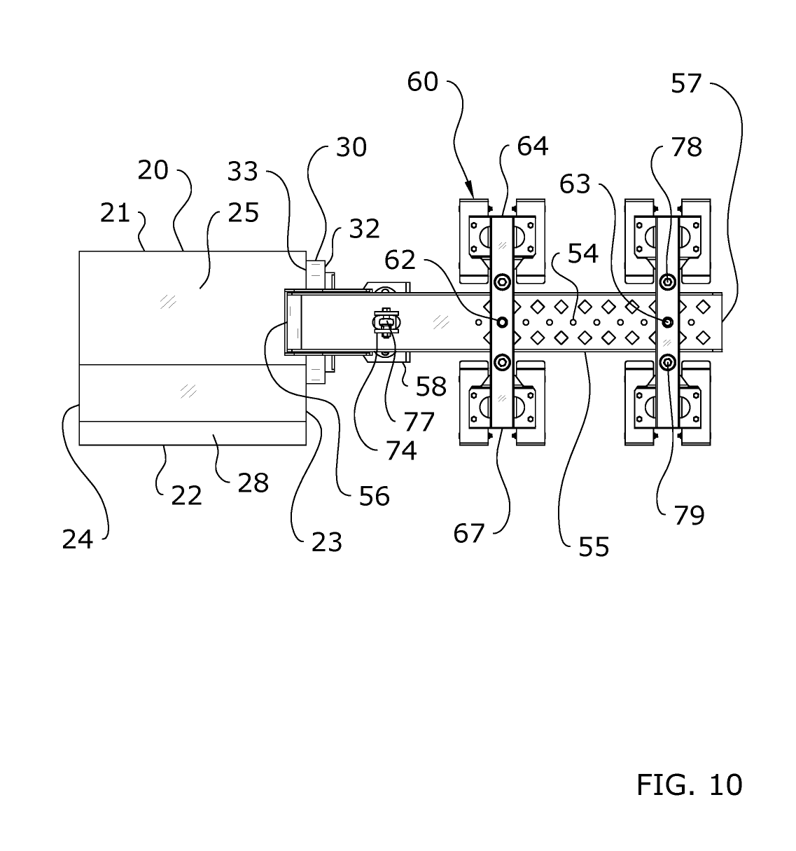

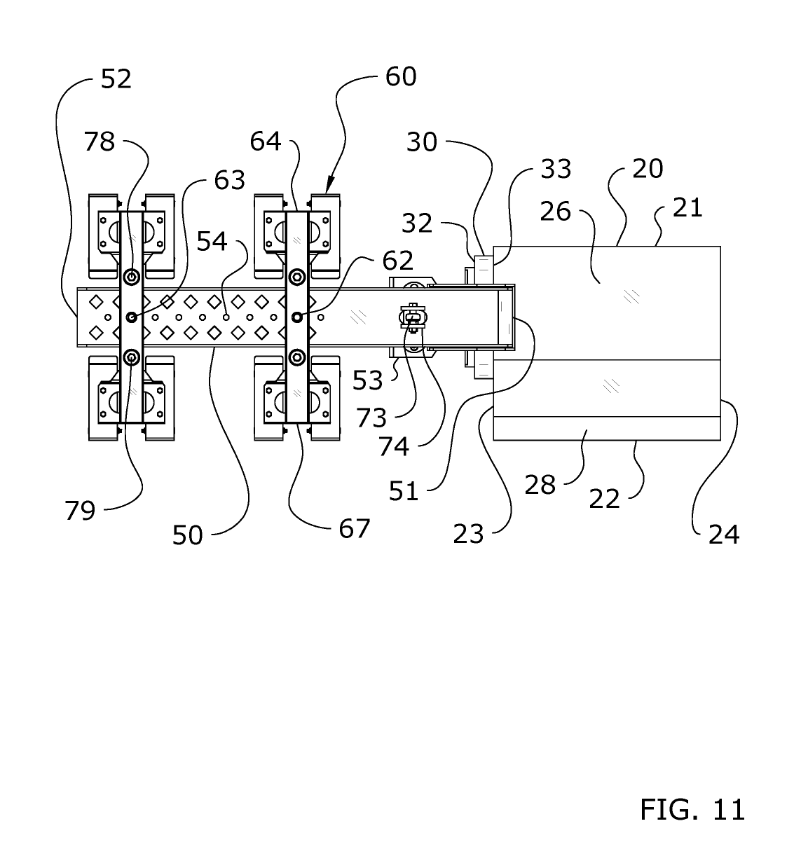

As best shown in FIGS. 1 and 7-8, the base unit 20 may comprise an upper end 21, a lower end 22, a front end 23, a rear end 24, a first side 25, and a second side 26. The shape, size, and configuration of the base unit 20 may vary in different embodiments and should not be construed as limited by the exemplary figures. While the figures illustrate separate motors 35, 80 positioned within the base unit 20, it should be appreciated that the motors 35, 80 could be positioned outside of the base unit 20.

The rear end 24 of the base unit 20 includes mount receivers 28 comprises slots or the like which may be utilized to removably secure the base unit 20 on a vehicle such as a forklift. It should be appreciated that, although receivers 28 are shown, various other methods or mechanisms may be utilized. For example, clamps, brackets, connectors, or the like could be utilized to removably connect the base unit 20 to a vehicle. In some embodiments, the base unit 20 may be directly connected or integrally formed with a vehicle such as a loader or the like.

The front end 23 of the base unit 20 generally includes the bearing 30 to which the arm adjustment hub 70 and spanner arms 40, 45 are connected. The bearing 30 may comprise a front end 32 to which the arm adjustment hub 70 is connected and a rear end 34 which is rotatably connected to the front end 23 of the base unit 20.

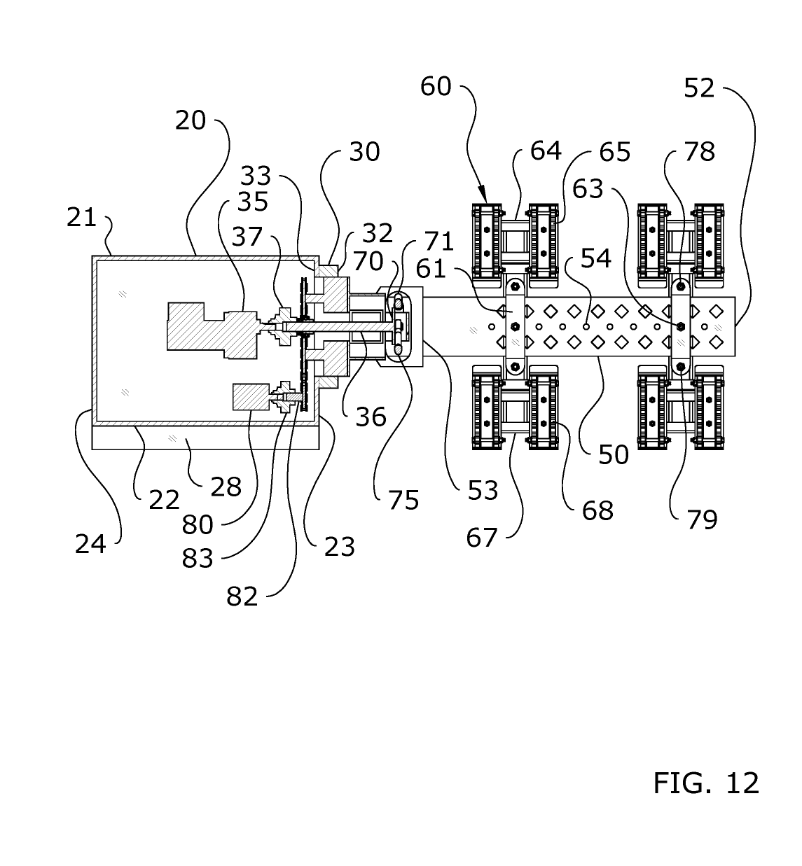

As shown in FIG. 12, the base unit 20 may house a first motor 35 and a second motor 80. The first motor 35 controls the adjustment of the spanner arms 40, 45 either inwardly toward each other to grasp a container 12 or outwardly away from each other to release a container 12. The second motor 80 controls the rotational movement of the bearing 30; which causes the rotation of the spanner arms 40, 45 to invert any container stored within the spanner arms 40, 45.

Continuing to reference FIG. 12, one exemplary configuration for the motors 35, 80 is shown. It should be appreciated that, while FIG. 12 illustrates to discrete motors 35, 80 comprising a first motor 35 and a second motor 80, in some embodiments more or less motors 35, 80 could be utilized to provide the functionality of both opening/closing the spanner arms 40, 45 and rotating the bearing 30.

The figures illustrate a first motor 35 which includes a rotatable first drive shaft 36 that is connected to the arm adjustment hub 70. The first drive shaft 36 may extend through a first torque limiter 37 before connecting to the arm adjustment hub 70 to prevent damage to the unit. The first motor 35 may comprise a gas motor, hydraulic motor, electric motor, or the like.

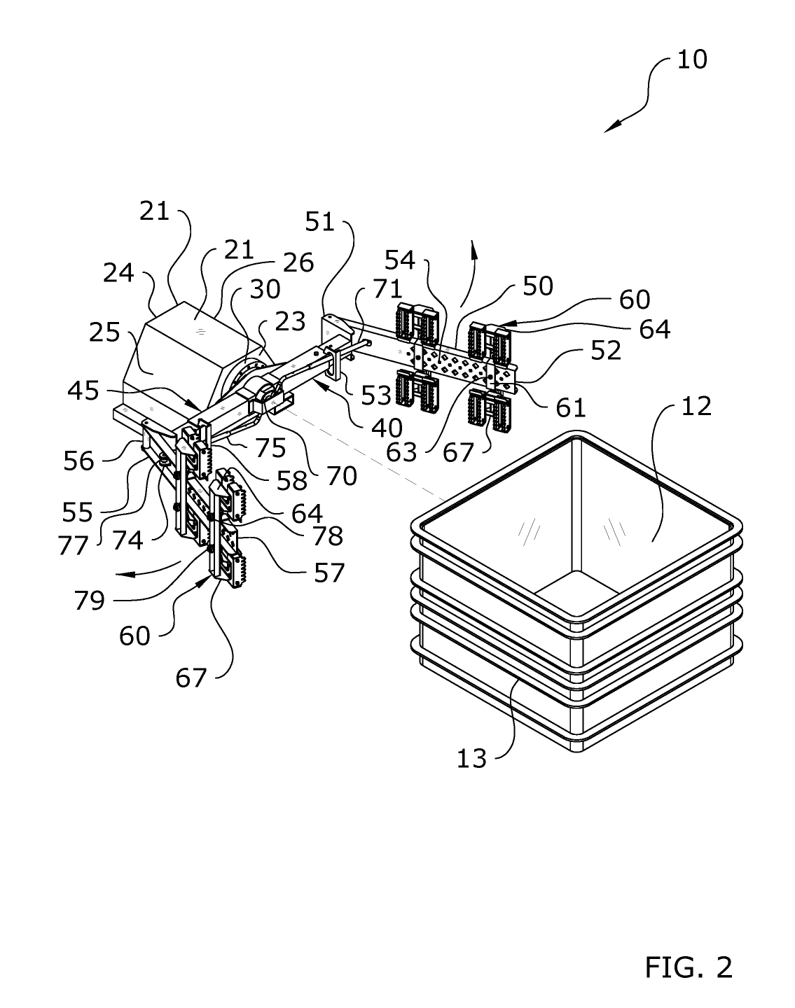

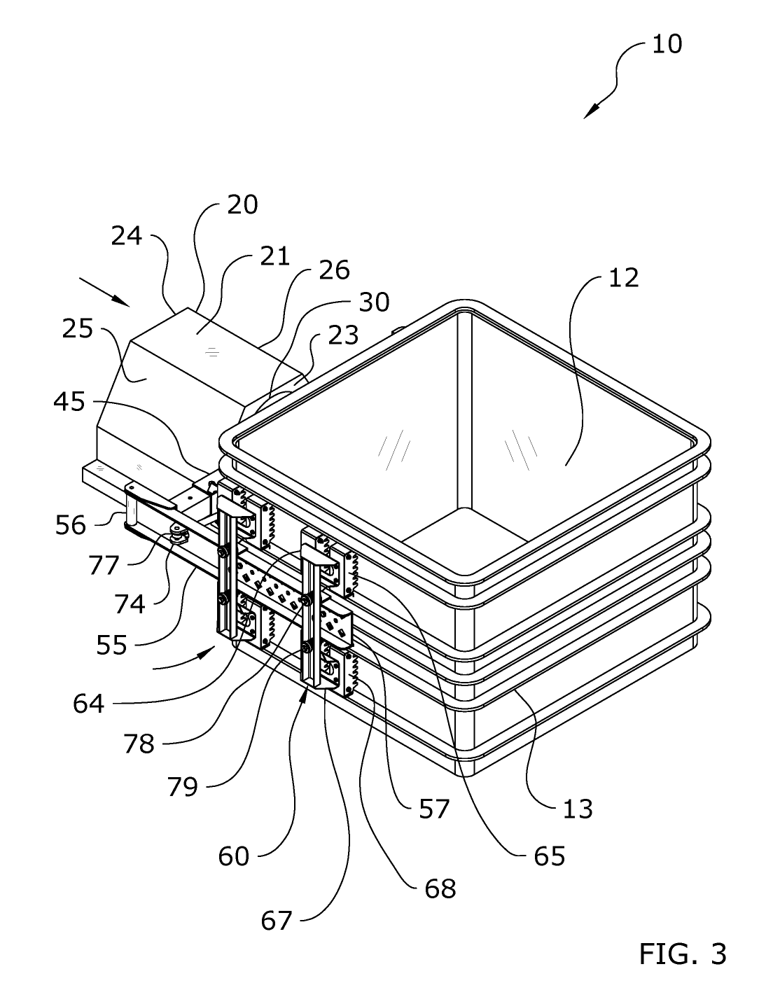

As the first drive shaft 36 is rotated in a first direction, the arm adjustment hub 70 will rotate in the same direction to open the spanner arms 40, 45 as shown in FIG. 2. As the first drive shaft 36 is rotated in a second direction, the arm adjustment hub 70 will rotate in the second direction to close the spanner arms 40, 45 as shown in FIG. 3. A slip clutch (not shown) may also be provided. The adjustment of the spanner arms 40, 45 is discussed in more detail in the below section.

FIG. 12 also illustrates a second motor 80 which includes a second rotatable drive shaft 82 that is connected to the bearing 30. The second drive shaft 82 may extend through a second torque limiter 83 before connecting the bearing 30 to prevent damage to the unit. The second motor 80 may comprise a gas motor, hydraulic motor, electric motor, or the like.

As the second drive shaft 82 is rotated in a first direction, the bearing 30 will rotate the spanner arms 40, 45 to an inverted position. As the second drive shaft 82 is rotated in a second direction, the bearing 30 will rotate the spanner arms 40, 45 back to the original position. A slip clutch (not shown) may also be provided to aid in functionality of the second motor 80. In some embodiments, sprockets and chains may interconnect the second drive shaft 82 with the bearing 30 so as to impart the rotational force from the second motor 80 to the bearing 30.

### C. Spanner and Gripper Arms.

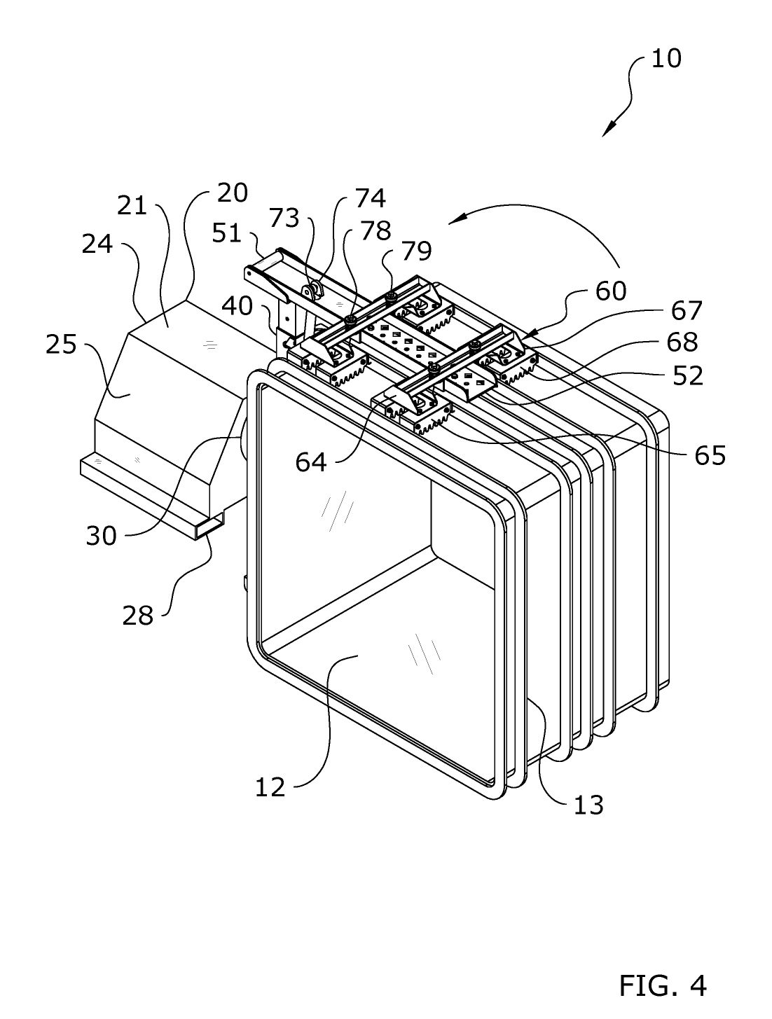

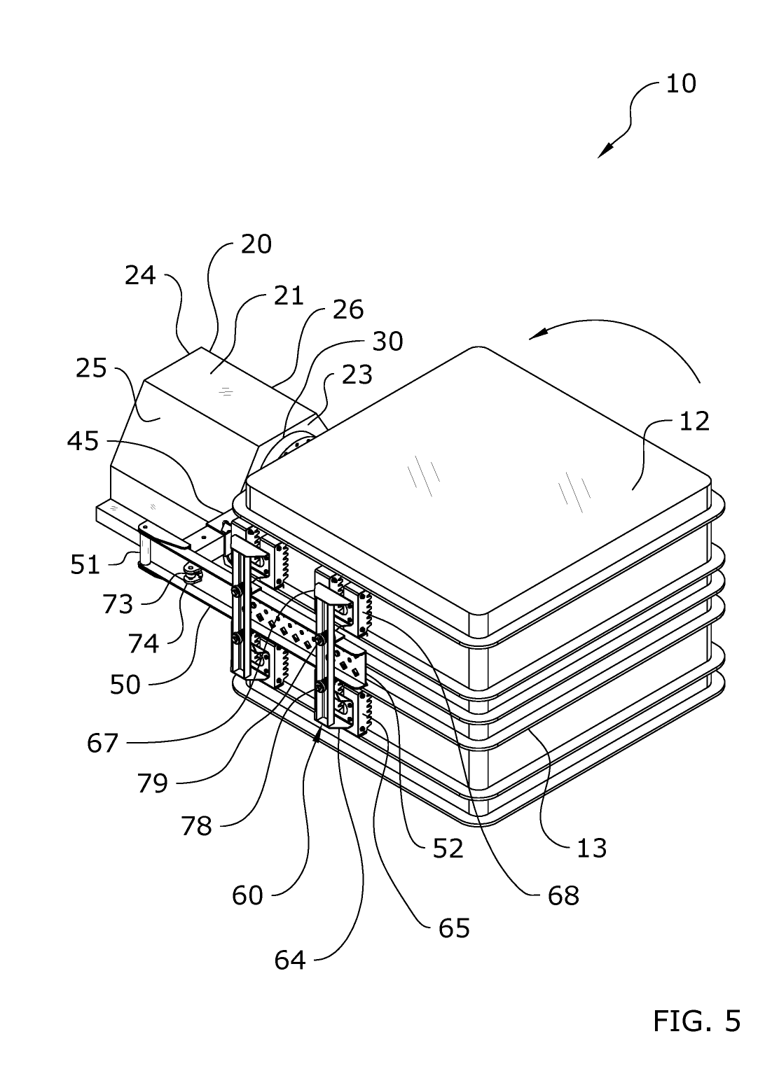

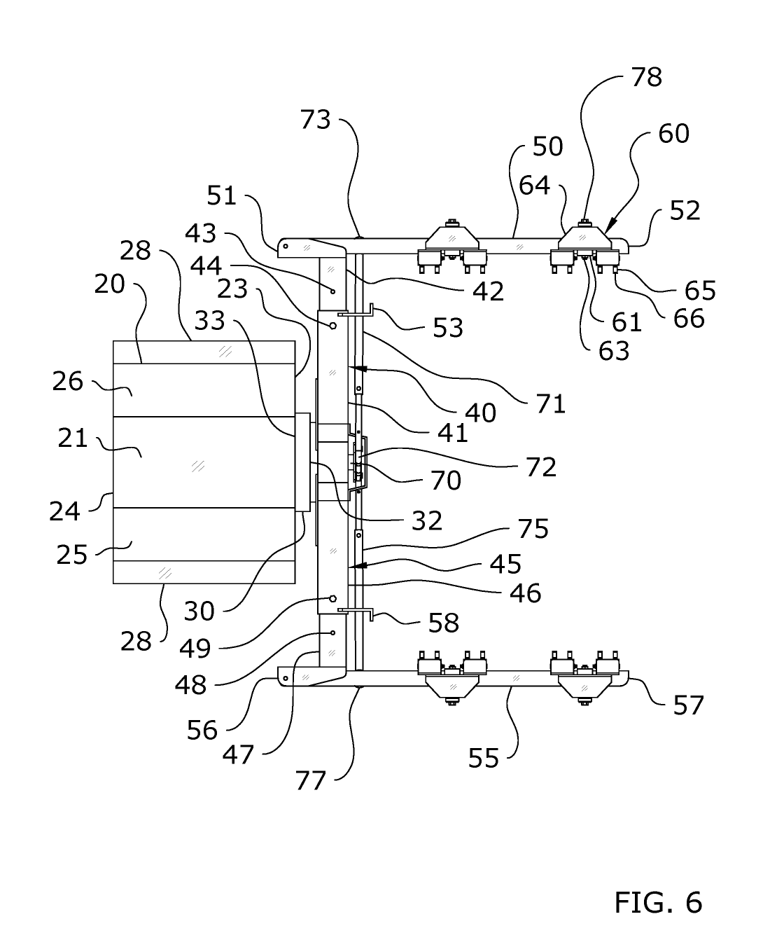

As shown in FIGS. 1-6, a pair of spanner arms 40, 45 extend outwardly from the bearing 30 in opposite directions. As the bearing 30 is rotated, the spanner arms 40, 45 are rotated with the bearing 30 between an original position and an inverted position. In most embodiments, a first spanner arm 40 extends in a first direction from the bearing 30 and the second spanner arm 45 extends in a second direction from the bearing 30.

The first spanner arm 40 may be adjustable in length so as to accommodate differently-sized containers 12. One method of adjusting the first spanner arm 40 may comprise the use of a first portion 41 and a second portion 42 which are adjustment with respect to each other—such as in a nested configuration. As shown in the figures, the second portion 42 may be adjustable within the first portion 41 to adjust the effective length of the first spanner arm 40. First adjustment apertures 43 on the first and second portions 41, 42 are utilized in combination with a first adjustment bolt 44 to lock the first spanner arm 40 at a desired length.

The second spanner arm 45 may also be adjustment in length, including the use of a first portion 46 and a second portion 47 nested within the first portion 46. Second adjustment apertures 48 may be utilized in combination with a second adjustment bolt 49 to selectively lock the first and second portions 46, 47 of the second spanner arm 45 together to maintain the second spanner arm 45 in a desired configuration at a desired length. It should be appreciated, however, that in some embodiments the spanner arms 40, 45 may not be adjustable; such as if it is known that the portable box inverter 10 will only be inverting one type of container 12.

As shown in FIGS. 1 and 2, a first gripper arm 50 extends substantially perpendicularly with respect to the first spanner arm 40 and a second gripper arm 55 extends substantially perpendicularly with respect to the second spanner arm 45. The gripper arms 50, 55 may be rotatably adjusted outwardly to allow a container 12 to be positioned therebetween, and rotatably adjusted inwardly to engage with the container 12 and thus grasp the container 12 between the gripper arms 50, 55 for inversion.

The first gripper arm 50 may include a first end 51 and a second end 52. The first end 51 of the first gripper arm 50 is connected to second portion 42 of the first spanner arm 40. The second gripper arm 55 may include a first end 56 and a second end 57; with the first end 56 of the second gripper arm 55 being connected to the second portion 47 of the second spanner arm 45. Preferably, the gripper arms 50, 55 are rotatably connected to the spanner arms 40, 45, such as by a hinge as shown in the figures.

Stoppers 53, 58 may be provided to prevent over-adjustment of the gripper arms 50, 55 with respect to the spanner arms 40, 45; such as a first stopper 53 for the first gripper arm 50 and a second stopper 58 for the second gripper arm 55 as shown in FIGS. 1 and 2. The stoppers 53, 58 may comprise projections or the like extending inwardly from the respective gripper arms 50, 55 as shown in the figures. The positioning of the stoppers 53, 58 along the length of the gripper arms 50, 55 may vary in different embodiments.

Each of the gripper arms 50, 55 may include a plurality of gripper receivers 54, 59 extending along their length. The gripper receivers 54, 59 are provided such that the grippers 60 of the present invention may be removably connected to different locations along the length of the gripper arms 50, 55. The gripper receivers 54, 59 may comprise brackets, clasps, clips, adhesive pads, or the like to which the grippers 60 may be removably connected. In a preferred embodiment as shown in the figures, the gripper receivers 54, 59 may comprise openings through which a bracket bolt 63 may be extended to secure the grippers 60 to the gripper arms 50, 55.

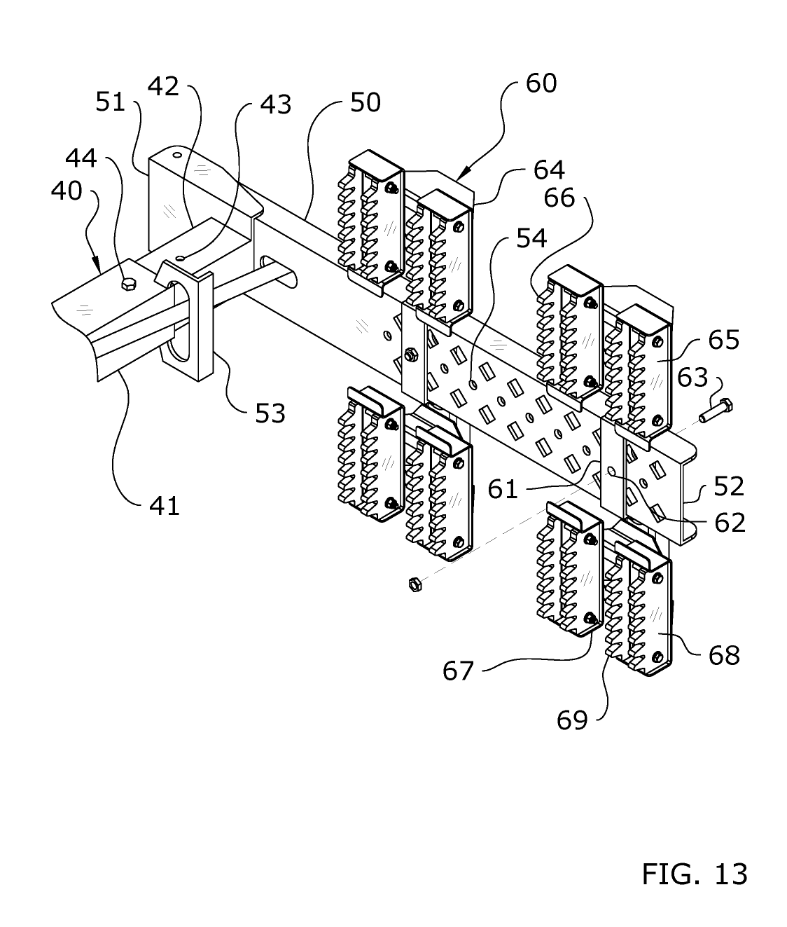

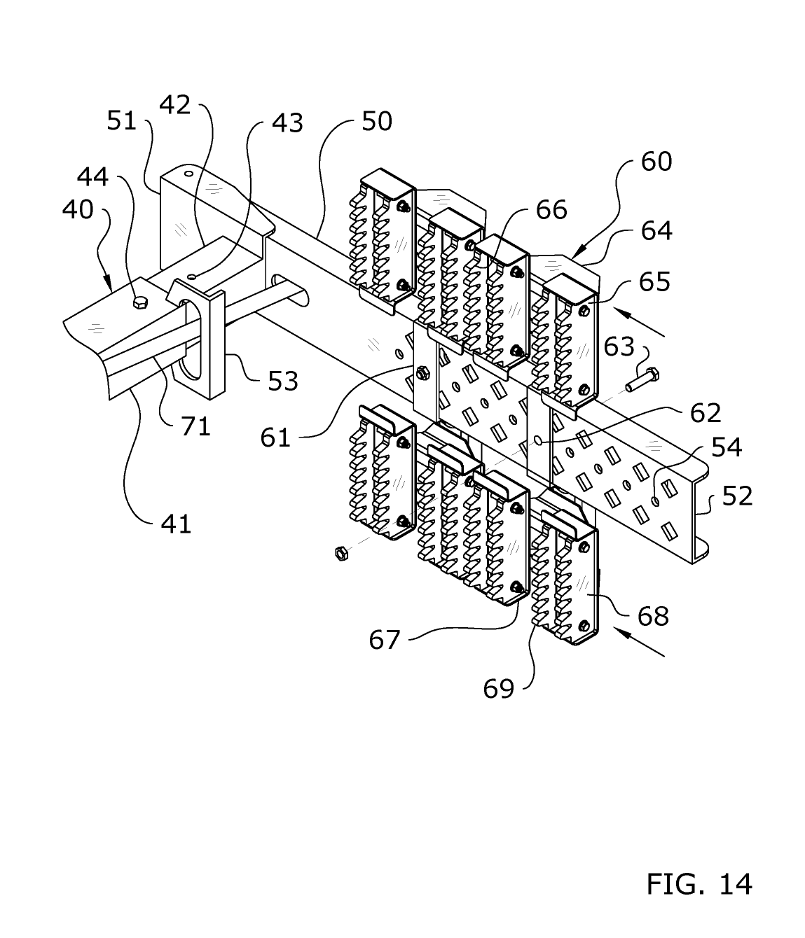

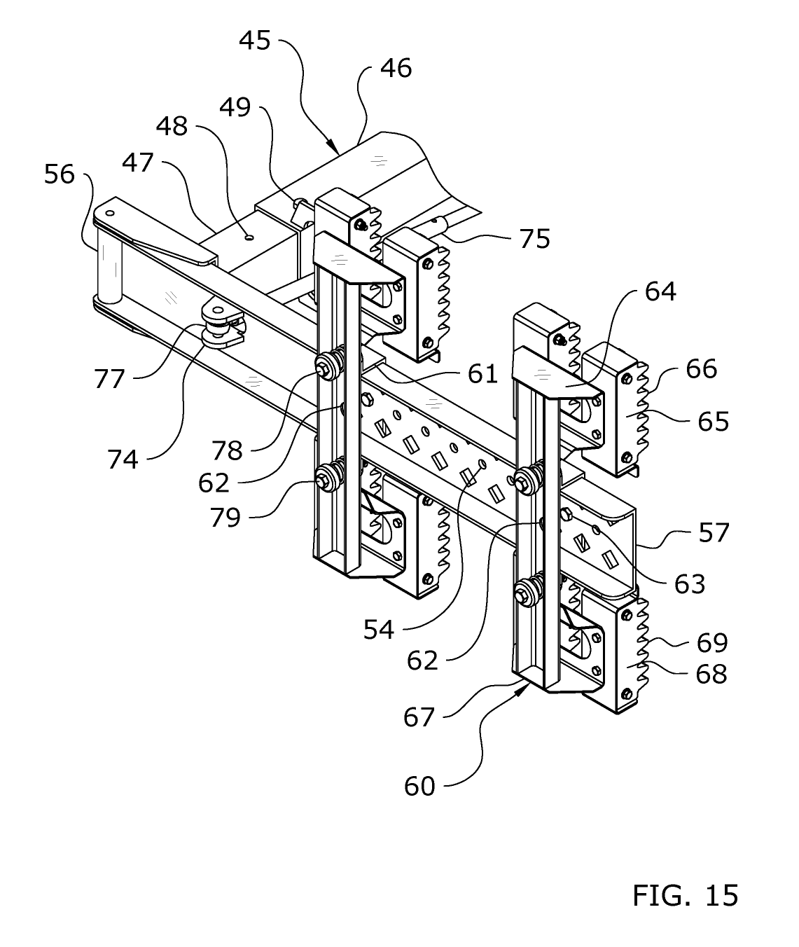

As best shown in FIGS. 13-15, a plurality of grippers 60 may be provided which are adapted to grip the container 12 between the gripper arms 50, 55. The grippers 60 may comprise various configurations and should not be construed as limited by the exemplary figures. Further, the number of grippers 60 used may vary depending on the type of container 12 being inverted. The present invention is well-suited for a number of different configurations as it relates to grippers 60; with the gripper arms 50, 55 being adapted to support multiple grippers 60 at once if necessary for additional gripping force.

As shown in the figures, each gripper 60 generally comprises an attachment bracket 61 which is removably connected to the gripper arm 50, 55. The attachment bracket 61 may include a bracket opening 62 which is preferably aligned with one of the gripper receivers 54, 59 and secured thereto with a bracket bolt 63. Using this configuration, the grippers 60 may be positioned at various locations along the length of each gripper arm 50, 55.

The grippers 60 further comprise an upper support 64 which extends upwardly from the attachment bracket 61 and a lower support 67 which extends downwardly from the attachment bracket 61 as shown in the figures. The upper support 64 may include one or more upper gripper pads 65 and the lower support 67 may include one or more lower gripper pads 68. Each of the gripper pads 65, 68 may include gripper projections 66, 69 which are adapted to increase gripping power between the grippers 60 and the container 12, such as by engaging with ridges 13 on the container 12. The spacing, type, shape, and configuration of the gripper projections 66, 69 may vary in different embodiments. Preferably, the upper gripper pads 65 include upper gripper projections 66 and the lower gripper pads 68 include lower gripper projections 69.

The gripper arms 50, 55 are opened and closed by the first motor 35 as described herein. When opened, the gripper arms 50, 55 are adjusted outwardly away from the base unit 20 to allow a container 12 to be positioned therebetween. When closed, the gripper arms 50, 55 are adjusted inwardly toward each other and the base unit 20 to engage around the container 12 as shown in the figures.

One method of adjusting the gripper arms 50, 55 is shown in the figures. As shown in the exemplary figures, an arm adjustment hub 70 may be connected to the front end 32 of the bearing 30. The arm adjustment hub 70 is rotatable in two directions, but is preferably limited from a full rotation. A first linkage 71 is connected between the arm adjustment hub 70 and the first gripper arm 50 and a second linkage 75 is connected between the arm adjustment hub 70 and the second gripper arm 55. The linkages 71, 75 may extend along the spanner arms 40, 45 as shown in the figures.

As shown in the figures, the first linkage 71 comprises a first end 72 connected to the arm adjustment hub 70 and a second end 73 which includes a pivot connector 74 that is connected to the first gripper arm 50. The second linkage 75 comprises a first end 76 connected to the arm adjustment hub 70 and a second end 77 which includes a pivot connector 74 that is connected to the second gripper arm 55. Various other configurations may be utilized. As the arm adjustment hub 70 rotates in a first direction, the linkages 71, 75 will push the gripper arms 50, 55 outwardly to open them up. As the adjustment hub 70 rotates in a second direction, the linkages 71, 75 will pull the gripper arms 50, 55 inwardly to close them around the container 12.

Springs cushions 78, 79 may be provided on the grippers 60 to allow a little bit of displacement of the gripper arms 50, 55 when gripping the container 12, to prevent too much pressure on the sides of the container 12. As shown in the figures, each gripper 60 may include upper spring cushions 78 positioned above the attachment bracket 61 and lower spring cushions 79 positioned beneath the attachment bracket 61.

### D. Operation of Preferred Embodiment.

In use, the base unit 20 may first be connected to a vehicle, though in some embodiments the base unit 20 may be integrated with such a vehicle. In the former embodiment, the vehicle may connect to and lift the base unit 20 by engaging with the mount receivers 28. For example, if the vehicle is a forklift, the forklift may engage with the mount receivers 28 to connect to the base unit 20.

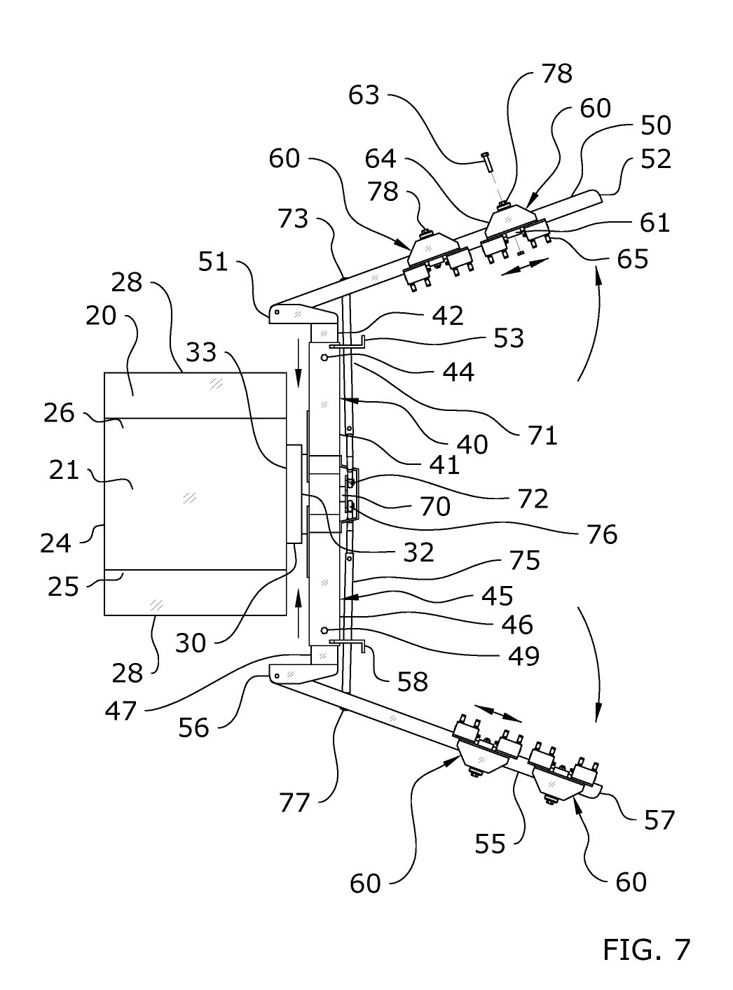

With the base unit 20 connected to the vehicle, the base unit 20 may be moved into place. The gripper arms 50, 55 will be opened up into an opened position by engaging the first motor 35. More specifically, the first motor 35 may be activated to rotate the arm adjustment hub 70 in a first direction. The linkages 71, 75 will push the gripper arms 50, 55 outwardly away from each other and the base unit 20 such as shown in FIG. 7. The gripper arms 50, 55, in their opened position, may then be placed around the container 12 such as shown in FIG. 2.

With the gripper arms 50, 55 in the open position around the container 12, the gripper arms 50, 55 may be closed around the container 12 to grip the container 12 between the gripper arms 50, 55. The first motor 35 is activated to rotate the arm adjustment hub 70 in a second direction. The linkages 71, 75 will pull the gripper arms 50, 55 inwardly toward each other and the base unit 20 to engage with the container 12. The container 12 will then be secured between the gripper arms 50, 55 by the grippers 60.

With the container 12 secured between the gripper arms 50, 55, the container 12 may be inverted. The second motor 80 is activated to rotate the bearing 30, which will rotate the spanner arms 40, 45 and gripper arms 50, 55; thus rotating the container 12 into an inverted position. The container 12 may then be emptied of its contents. When completed, the second motor 80 may be activated again to rotate the bearing 30 such that the container 12 is upright again. At this point, the gripper arms 50, 55 may be opened up to release the container 12, the vehicle moved away from the container 12, and the gripper arms 50, 55 closed again awaiting further usage.

The present invention is well-suited to be adjusted for various different types of containers 12. The effective length of the spanner arms 40, 45 may be adjusted using the adjustment apertures 43, 48 and adjustment bolts 44, 49 as described herein. The placement of the grippers 60 may be adjusted by using the bracket bolts 63 in combination with the gripper receivers 54, 59 and bracket openings 62. Any number of grippers 60 may be removably connected to the gripper arms 50, 55 in this manner in any number of spacings.

Unless otherwise defined, all technical and scientific terms used herein have the same meaning as commonly understood by one of ordinary skill in the art to which this invention belongs. Although methods and materials similar to or equivalent to those described herein can be used in the practice or testing of the portable box inverter, suitable methods and materials are described above. All publications, patent applications, patents, and other references mentioned herein are incorporated by reference in their entirety to the extent allowed by applicable law and regulations. The portable box inverter may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

What is claimed is:

1. A portable box inverter, comprising:
a base unit connected to a vehicle;
a bearing rotatably connected to the base unit;
a first spanner arm extending from the bearing in a first direction;
a second spanner arm extending from the bearing in a second direction;
a first gripper arm extending from a distal end of the first spanner arm;
a second gripper arm extending from a distal end of the second spanner arm;
a first gripper removably and adjustably connected to the first gripper arm; and
a second gripper removably and adjustably connected to the second gripper arm.

2. The portable box inverter of claim 1, wherein the first gripper comprises a first attachment bracket for removably connecting to the first gripper arm and the second gripper comprises a second attachment bracket for removably connecting to the second gripper arm.

3. The portable box inverter of claim 2, wherein the first gripper arm includes a plurality of first gripper receivers and wherein the second gripper arm includes a plurality of second gripper receivers.

4. The portable box inverter of claim 3, wherein the first gripper is removably connected to the first gripper arm by a first bracket bolt extending through the first gripper and one of the first gripper receivers, wherein the second gripper is removably connected to the second gripper arm by a second bracket bolt extending through the second gripper and one of the second gripper receivers.

5. The portable box inverter of claim 4, wherein the first gripper includes a first spring cushion and wherein the second gripper includes a second spring cushion.

6. The portable box inverter of claim 1, further comprising an arm adjustment hub connected to the bearing.

7. The portable box inverter of claim 6, wherein the first spanner arm extends in a first direction with respect to the arm adjustment hub and wherein the second spanner arm extends in a second direction with respect to the arm adjustment hub.

8. The portable box inverter of claim 7, wherein rotation of the arm adjustment hub in a first direction adjusts the first gripper arm and the second gripper arm outwardly and wherein rotation of the arm adjustment hub in a second direction adjusts the first gripper arm and the second gripper arm inwardly.

9. The portable box inverter of claim 8, further comprising a first motor for rotating the arm adjustment hub.

10. The portable inverter of claim 9, further comprising a second motor for rotating the bearing.

11. A portable box inverter, comprising:
a base unit comprising a front end and a rear end, wherein the rear end of the base unit is connected to a vehicle;
a bearing rotatably connected to the front end of the base unit;
a first spanner arm extending from the bearing in a first direction;
a second spanner arm extending from the bearing in a second direction;
a first gripper arm extending from a distal end of the first spanner arm;
a second gripper arm extending from a distal end of the second spanner arm;
an arm adjustment hub connected to the bearing, wherein the arm adjustment hub is adapted to rotate the first gripper arm and the second gripper arm inwardly towards each other or outwardly away from each other;
a first gripper removably and adjustably connected to the first gripper arm; and
a second gripper removably and adjustably connected to the second gripper arm.

12. The portable inverter of claim 11, wherein the first spanner arm and the second spanner arm each rotate with the bearing.

13. The portable inverter of claim 12, further comprising a first motor for rotating the bearing.

14. The portable inverter of claim 13, wherein rotation of the arm adjustment hub in a first direction rotates the first gripper arm and the second gripper arm away from each other.

15. The portable inverter of claim 14, wherein rotation of the arm adjustment hub in a second direction rotates the first gripper arm and the second gripper arm toward each other.

16. The portable inverter of claim 15, further comprising a first linkage connecting the arm adjustment hub to the first gripper arm and a second linkage connecting the arm adjustment hub to the second gripper arm.

17. The portable inverter of claim 16, further comprising a second motor for rotating the arm adjustment hub.

18. The portable box inverter of claim 17, wherein the first gripper comprises a first attachment bracket for removably connecting to the first gripper arm and the second gripper comprises a second attachment bracket for removably connecting to the second gripper arm.

19. The portable box inverter of claim 18, wherein the first gripper arm includes a plurality of first gripper receivers and wherein the second gripper arm includes a plurality of second gripper receivers.

20. The portable box inverter of claim 19, wherein the first gripper is removably connected to the first gripper arm by a first bracket bolt extending through the first gripper and one of the first gripper receivers, wherein the second gripper is removably connected to the second gripper arm by a second bracket bolt extending through the second gripper and one of the second gripper receivers.
